(19) United States
(12) Patent Application Publication
(10) Pub. No.: US 2025/0293328 A1
(43) Pub. Date: Sep. 18, 2025

(54) DISMANTLING SYSTEM OF SPENT LITHIUM ION BATTERY PACK

(71) Applicant: KOREA ZINC CO., LTD., Seoul (KR)

(72) Inventors: In Seung SHIN, Ulsan (KR); Hyeoung Seog PARK, Yeosu-si (KR)

(21) Appl. No.: 18/605,820

(22) Filed: Mar. 15, 2024

(51) Int. Cl. H01M 10/54; B09B 3/35; B09B 101/16; B25J 11/00; H01M 50/383

(52) U.S. Cl. CPC H01M 10/54; B09B 3/35; H01M 50/383; B09B 2101/16; B25J 11/0055

(57) ABSTRACT

The system for dismantling the spent lithium-ion battery pack includes: a transfer section including transfer rails and a gantry robot on the transfer rails; a discharge processing section including an index table on which a discharging task of discharging a battery pack is performed; a battery disassembly section including a worktable on which a disassembly task is performed to cut connections of the battery pack, disassembly robots, and first transfer trolleys; and a cell extraction section including an extraction robot, a second transfer trolley configured to carry out battery cells, of which the connections have been cut by the disassembly task, to the outside, and a third transfer trolley configured to carry out a tray on which the battery cells are placed to the outside. The index table, the worktable, the second transfer trolley, and the third transfer trolley are arranged directly below the transfer rail.

### TECHNICAL FIELD

The present disclosure relates to a spent lithium-ion battery pack dismantling system. More specifically, the present disclosure relates to a spent lithium-ion battery pack dismantling system that facilitates system construction and improves task efficiency through a configuration in which various components involved in a battery pack dismantling task are arranged in a row directly below a transfer rail.

### BACKGROUND

With the advancement of commercialization of electric vehicles, the emissions of waste lithium secondary batteries are increasing along with the increasing demand for lithium secondary batteries used as a vehicle power source.

However, spent lithium secondary batteries contain electrolyte, which is a hazardous substance, and cause environmental pollution when discarded without any special treatment. Therefore, various attempts are being made to reliably dismantle and dispose of spent lithium secondary batteries, and to recover economically valuable metals such as an electrode plate metal (copper or aluminum) or active materials such as nickel, cobalt, manganese, or lithium (hereinafter, referred to as a “valuable metal”).

Accordingly, in Patent Document 1 below, the applicant of the present application disclosed a spent lithium secondary battery batch-processing system, which corresponds to a technology for recovering valuable metals by using a plurality of physical and chemical processes after dismantling the spent lithium secondary batteries in units of cells.

As illustrated in FIG. 1, the system includes a disassembly and processing section 100, a crushing section 200, an alkaline immersion section 300, a precipitation section 400, a heat treatment section 500, a classification section 600, and a valuable metal recovery section 700.

Lithium secondary batteries for vehicles usually have a structure in which multiple single cells are connected in series or parallel to form a battery module, and these modules are integrated to form a battery pack. As illustrated in FIG. 2, in the disassembly and processing section 100, a plurality of robots 131, 133, and 135 are arranged in a row, and a work arm of each of the robots 131, 133, and 135 is detachably equipped with a laser head or a plurality of tools to perform a dismantling task in units of packs, modules, or cells.

In addition, in order to purify electrolyte vapor leaking during the dismantling process, a vacuum suction facility 150 and a vapor treatment tank 155 are provided around each of the robots 131, 133, and 135.

It takes a considerable amount of time to perform transfer for dismantling in units of packs, modules, or cells, resulting in low task efficiency. In particular, it is necessary to provide redundant facilities (a worktable, a conveyor, a lifting device, and the like) for each of the robots 131, 133, and 135. This was also considered to be inefficient in view of system construction cost and management, and thus the present disclosure was made.

### RELATED ART

### Patent Document

(Patent Document 1) KR 10-2334855 B1 (issued on Nov. 30, 2021)

### SUMMARY

The present disclosure is to provide a system for dismantling a spent lithium-ion battery pack capable of shortening the transfer time and avoiding redundant facilities by improving the configuration and arrangement of facilities.

In order to solve the above-mentioned technical problems, a system for dismantling a spent lithium-ion battery pack of the present disclosure includes: a transfer section including a pair of transfer rails and a gantry robot provided on the transfer rails; a discharge processing section including an index table on which a discharging task of discharging a spent lithium-ion battery pack is performed; a battery disassembly section including a worktable on which a disassembly task of disassembling battery cells is performed to cut electrical and mechanical connections of the spent lithium-ion battery pack, a pair of disassembly robots, and a plurality of first transfer trolleys, which are disposed adjacent to the worktable; and a cell extraction section including an extraction robot, a second transfer trolley disposed adjacent to the extraction robot and configured to carry out battery cells, of which the electrical and mechanical connections have been cut by the disassembly task, to the outside, and a third transfer trolley configured to carry out a tray on which the battery cells are placed to the outside. The index table, the worktable, the second transfer trolley, and the third transfer trolley are arranged directly below the transfer rail.

In the system for dismantling the spent lithium-ion battery pack of the present disclosure, the gantry robot includes a telescopic rod, and a rotatable clamping unit is provided at an end of the telescopic rod.

In the system for dismantling the spent lithium-ion battery pack of the present disclosure, the disassembly robots include a first disassembly robot configured to perform the disassembly task by cutting the electrical and mechanical connections of the battery body, and a second disassembly robot configured to perform the task of clamping a specific portion of the spent lithium-ion battery pack during the disassembly task and during a task of unloading components obtained from cutting the electrical and mechanical connections onto the first transfer trolleys.

In the system for dismantling the spent lithium-ion battery pack of the present disclosure further includes a fire prevention unit provided in the battery disassembly section, and the fire prevention unit includes a fire detection sensor, a cover, and an automatic exhaust device provided on the worktable.

In the system for dismantling the spent lithium-ion battery pack of the present disclosure, the extraction robot is configured to perform an additional cutting task on the battery cells remaining on the tray due to incomplete cutting of some of the disassembled battery cells, and to unload the additionally cut battery cells on the second transfer trolley.

### BRIEF DESCRIPTION OF DRAWINGS

FIG. 1 is a configuration view illustrating a batch-processing system for a spent lithium secondary battery according to the related art.

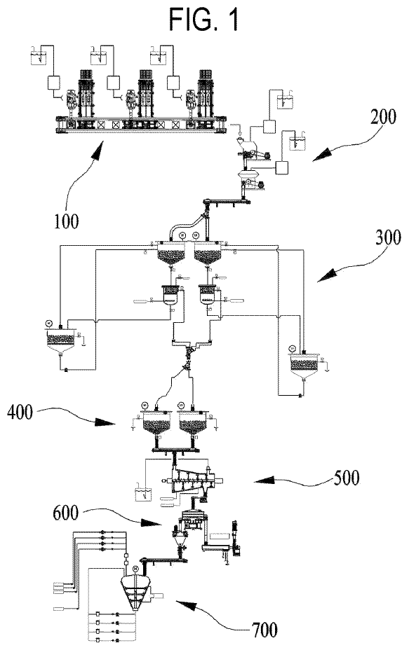

FIG. 2 is an enlarged configuration view illustrating a disassembly and processing section of batch-processing system for the spent lithium secondary battery according to the related art.

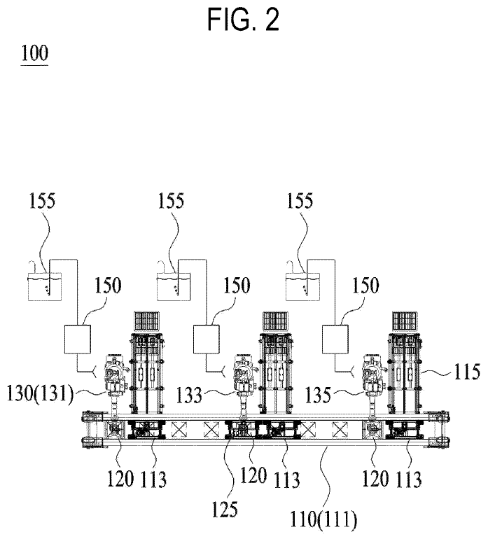

FIG. 3 is a perspective view illustrating a system for dismantling a spent lithium-ion battery pack according to the present disclosure.

FIG. 4 is a perspective view illustrating a transfer section of the system for dismantling the spent lithium ion battery pack according to the present disclosure.

FIG. 5 is a plan view illustrating a battery disassembly section of the system for dismantling the spent lithium ion battery pack according to the present disclosure.

FIG. 6 is an enlarged perspective view illustrating a worktable of the system for dismantling the spent lithium-ion battery pack according to the present disclosure.

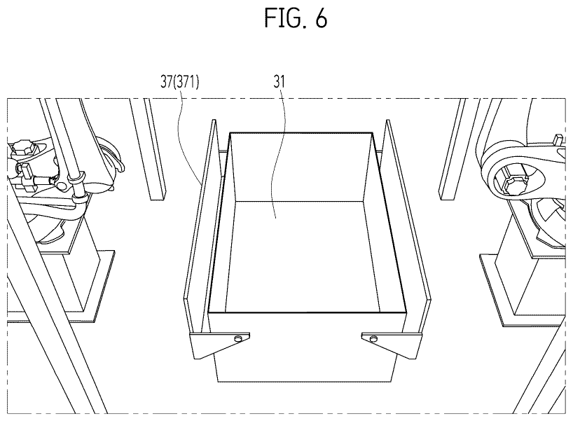

FIG. 7 is a perspective view illustrating a cell extraction section of the system for dismantling the spent lithium-ion battery pack according to the present disclosure.

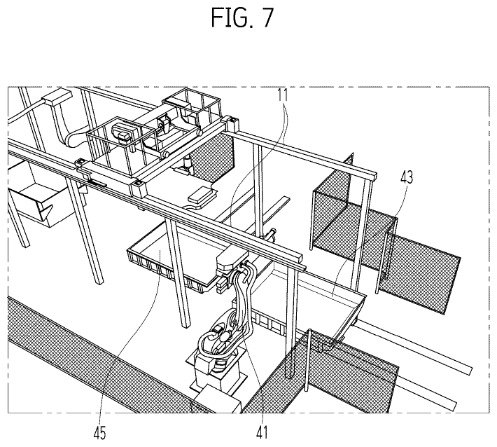

### DETAILED DESCRIPTION

Hereinafter, preferred embodiments of the present disclosure will be described in more detail with reference to the attached drawings.

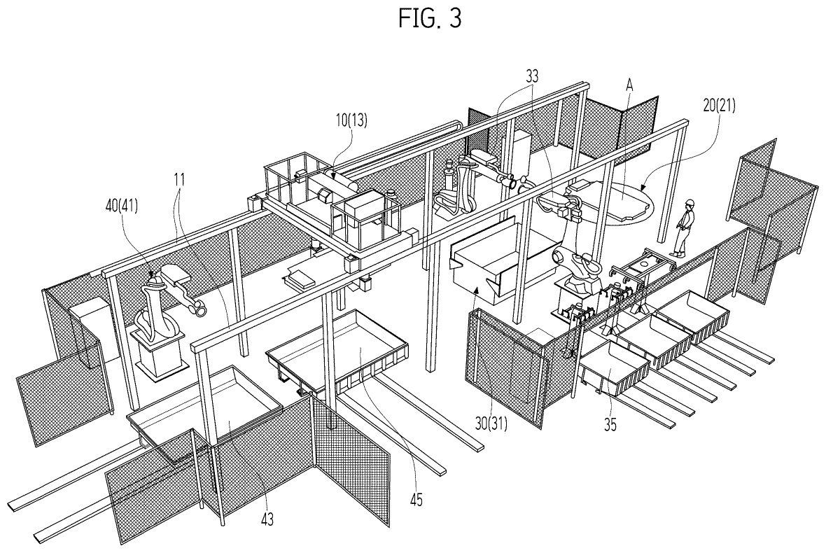

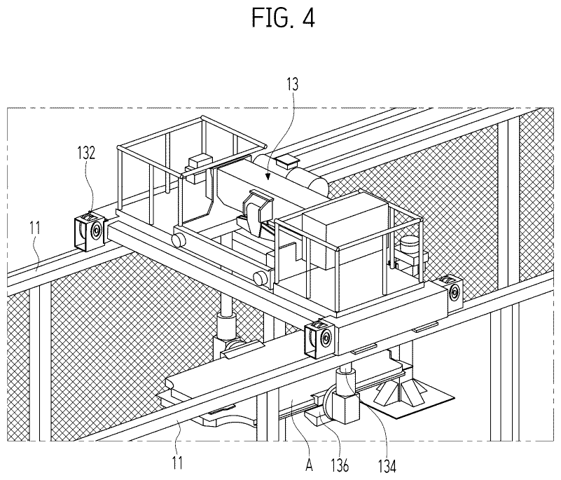

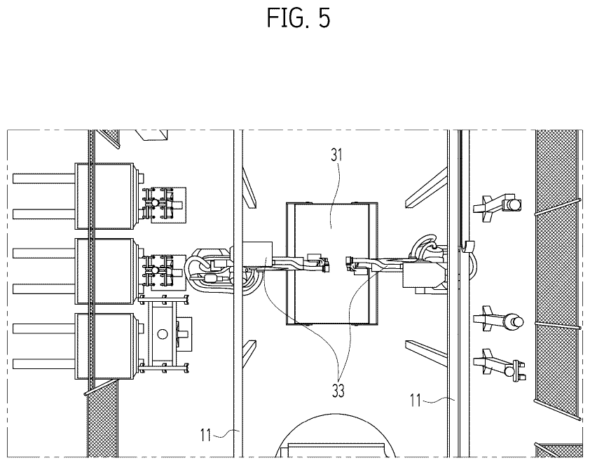

FIG. 3 is a perspective view illustrating a system for dismantling a spent lithium-ion battery pack according to the present disclosure, FIG. 4 is a perspective view illustrating a transfer section of the system for dismantling the spent lithium ion battery pack according to the present disclosure, and FIG. 5 is a plan view illustrating a battery disassembly section of the system for dismantling the spent lithium ion battery pack according to the present disclosure.

Referring to FIGS. 3 to 5, the system for dismantling the spent lithium-ion battery pack of the present disclosure includes a transfer section 10 and a discharge processing section 20, a battery disassembly section 30, and a cell extraction section 40, which are sequentially placed below the transfer section 10 to perform a discharge task, a disassembly task, and an extraction task (hereinafter, referred to as “unit tasks”), respectively, and a controller configured to control the operations of auxiliary devices of the above-mentioned various components.

Hereinafter, the specific details of the present disclosure will be described focusing on the above-mentioned components. First, the transfer section 10 is configured to hold a spent lithium-ion battery pack A and transfer the battery pack to the next unit work location. The transfer section 10 includes a pair of transfer rails 11 and a gantry robot 13 provided on the transfer rails 11.

The gantry robot 13 includes a wheel set 132 and a telescopic rod 134 for moving on the transfer rails 11 and a clamping unit 136 configured to hold a spent lithium-ion battery pack A is provided at an end portion of the telescopic rod 134. The clamping unit 136 includes a structure rotatable to turn over for battery cell dumping task which will be described later.

In addition to toxic substances, lithium-ion batteries contain organic solvents, which are explosive substances. Thus, when a short circuit occurs when dismantling a spent lithium-ion battery pack A while there is residual electricity in the spent battery, a fire or explosion may occur.

The discharge processing section 20 is configured to discharge residual electricity to prevent such fire or explosion. The discharge processing section 20 includes an index table 21 on which a discharging task is performed and includes an index table 21 disposed directly below the transfer rails 11.

The index table 21 can be rotated by an index motor, so that an input spent lithium-ion battery pack A can be rotated.

As a discharging method performed in the index table 21, electrical discharge using a discharger or wet discharge using an acidic solution may be adopted.

The battery disassembly section 30 is configured to cut the electrical and mechanical connections of a battery body (packs, modules, cells) from the spent lithium-ion battery pack A for which the discharging task has been completed in the discharge processing section 20, and collect and carry out components other than a tray (a cover, a frame, a cooling unit, a cable, or the like) (hereinafter, cut components will be referred to as “scraps”) to the outside. The battery disassembly section includes a worktable 31 on which a disassembly task is performed and which is disposed directly below the transfer rails 11, a pair of disassembly robots 33 disposed adjacent to the worktable 31, and a plurality of first transfer trolleys 35.

The worktable 31 is provided with a fixing jig configured to fix and center a spent lithium-ion battery pack A required for various tasks performed by the disassembly robots 33.

The pair of disassembly robots 33 include a first disassembly robot 33a configured to perform a disassembly task by cutting the electrical and mechanical connections of the battery body, and a second disassembly robot 33b configured to perform the task of clamping a specific portion of the spent lithium-ion battery pack A during the disassembly task and the task of unloading the cut scraps onto the first transfer trolleys 35.

For this purpose, a laser cutting tool, a bolting processing tool, a cable cutting tool, a cover handling tool, a scrap handling tool, a cable handling tool, and the like are provided around the disassembly robots 33, and the above-mentioned tools are detachably attached to the work arms of the disassembly robots 33.

Meanwhile, in order to disassemble a spent lithium-ion battery pack A, of which the configuration and structure vary depending on the vehicle type, the controller is input with information on the spent lithium ion battery pack A disassembly manual for each vehicle type, and based on this information, the controller instructs detailed disassembly tasks of the disassembly robots 33.

The cut scraps are classified and loaded on the first transfer trolleys 35 depending on the types of components.

Meanwhile, even if the discharge task is performed in the discharge processing section 20, electricity may remain in some modules or cells, which may cause an unexpected fire during the disassembly task.

Accordingly, it is recommended that the battery disassembly section 30 be further provided with a fire prevention unit 37, and the fire prevention unit 37 includes a fire detection sensor, a cover 371, and an automatic exhaust device (not illustrated) which are provided on the worktable 31.

When the occurrence of a fire is detected by the fire detection sensor, the controller covers the cover 371 to suppress the spread of the fire and at the same time instructs the operating devices in the system to stop operating.

The cell extraction section 40 is configured to perform a battery cell extraction task. The cell extraction section includes an extraction robot 41, a second transfer trolley 43 configured to carry out battery cells, and a third transfer trolley 45 configured to carry out a tray, wherein the second and third transfer trolleys are arranged adjacent to the extraction robot 41 and both placed directly below the transfer rails 11.

When the disassembly task is completed in the battery disassembly section 30, the spent lithium ion battery pack A disassembled in units of cells remains on the tray, and the gantry robot 13 holds this tray and first transfers the tray to a location directly above the second transfer trolley 43, then turns the tray over to dump the battery cells (battery cell dumping task), and then unloads the tray onto the third transfer trolley 45.

However, some of the disassembled battery cells are incompletely cut and remain on the tray even after the battery cell dumping task. The extraction robot 41 performs an additional cutting task to extract the corresponding battery cells, and then unload the battery cells onto the second transfer trolley 43. For this purpose, the work arm of the extraction robot 41 is equipped with a vision camera, a laser cutter, and a cell gripping unit.

According to the system for dismantling the spent lithium-ion battery pack of the present disclosure, since a pair of disassembly robots and an extraction robot are provided, and various components to be involved in a battery pack dismantling task are arranged in a row directly below the transfer rails, the length of transfer time can be shortened, and redundant facilities can be avoided, which further facilitates construction of a battery pack dismantling system, reduces system operating costs, and improves task efficiency as well as productivity.

As described above, in the dismantling system of the present disclosure, main battery pack dismantling tasks are intensively carried out in the battery disassembly section 30, transfer is also carried out through the transfer rails 11, which is a single configuration, and the task of carrying out disassembled scraps or battery cells is also performed by robots, which can significantly reduce the length of transfer time, unlike the related art.

In addition, since redundant facilities such as those in the related art are omitted, it is possible to reduce system construction costs and improve management efficiency.

Although the preferred embodiments of the present disclosure have been described above, it should be understood that the scope of the present disclosure covers those substantially equivalent to the embodiments of the present disclosure rather than being limited to the embodiments, and that various modifications can be made by a person ordinarily skilled in the art without departing from the spirit of the present disclosure.

What is claimed is:

1. A system for dismantling a spent lithium-ion battery pack, the system comprising:
a transfer section including a pair of transfer rails and a gantry robot provided on the transfer rails;
a discharge processing section including an index table on which a discharging task of discharging a spent lithium-ion battery pack is performed;
a battery disassembly section including a worktable on which a disassembly task of disassembling battery cells is performed to cut electrical and mechanical connections of the spent lithium-ion battery pack, a pair of disassembly robots, and a plurality of first transfer trolleys, which are disposed adjacent to the worktable; and
a cell extraction section including an extraction robot, a second transfer trolley disposed adjacent to the extraction robot and configured to carry out battery cells, of which the electrical and mechanical connections have been cut by the disassembly task, to an outside, and a third transfer trolley configured to carry out a tray on which the battery cells are placed to the outside,
wherein the index table, the worktable, the second transfer trolley, and the third transfer trolley are arranged directly below the transfer rails.

2. The system of claim 1, wherein the gantry robot includes a telescopic rod, and a rotatable clamping unit is provided at an end of the telescopic rod.

3. The system of claim 1, wherein the disassembly robots include a first disassembly robot configured to perform the disassembly task by cutting the electrical and mechanical connections of the battery body, and a second disassembly robot configured to perform the task of clamping a specific portion of the spent lithium-ion battery pack during the disassembly task and during a task of unloading components obtained from cutting the electrical and mechanical connections onto the first transfer trolleys.

4. The system of claim 1, further comprising:
a fire prevention unit provided in the battery disassembly section,
wherein the fire prevention unit includes a fire detection sensor, a cover, and an automatic exhaust device provided on the worktable.

5. The system of claim 1, wherein the extraction robot is configured to perform an additional cutting task on the battery cells remaining on the tray due to incomplete cutting of some of the disassembled battery cells, and to unload the additionally cut battery cells on the second transfer trolley.
